(19) United States
(12) Patent Application Publication
(10) Pub. No.: US 2026/0001571 A1
(43) Pub. Date: Jan. 1, 2026

(54) LONG DISTANCE VEHICLE-RATED EVENT RECOGNIZATION AND ALERT GENERATION TECHNIQUES

(71) Applicant: FCA US LLC, Auburn Hills, MI (US)

(72) Inventors: Shahin Nobari-Tabrizi, Auburn Hills, MI (US); Paul A Aldighieri, Auburn Hills, MI (US); Matthew A Taylor, Auburn Hills, MI (US)

(21) Appl. No.: 18/755,804

(22) Filed: Jun. 27, 2024

(51) Int. Cl. B60W 50/16; B60W 50/14; G07C 5/08

(52) U.S. Cl. CPC B60W 50/16; G07C 5/0816; B60W 2050/143; B60W 2050/146

(57) ABSTRACT

A vehicle-related event recognization and alert system includes a computing server associated with an original equipment manufacturer (OEM) of a plurality of OEM vehicles and configured to receive training data relating to a plurality of vehicle-related events, each vehicle-related event being a situation in which an encounter between a particular OEM vehicle and one or more objects occurred and train a vehicle-related event recognization model based on the received training data, wherein the trained vehicle-related event recognization model is configured to recognize a plurality of vehicle-related events and to be executed based on a set of input data to generate a model output indicative of one or more recognized vehicle-related events, and a computing device associated with the OEM and configured to obtain the model output and selectively generate an alert for the one or more recognized vehicle-related events.

### FIELD

The present application generally relates to vehicle artificial intelligence (AI) and, more particularly, to techniques for utilizing AI long distance vehicle-related event recognization and alert generation techniques.

### BACKGROUND

Over time, vehicles and their drivers may experience many encounters (e.g., collisions or near-miss collisions) with nearby objects of concern (other vehicles, pedestrians, animals, debris, etc.). These encounters may be particularly likely during specific vehicle-related events, such as environmental conditions affecting the vehicle or external situations involving the vehicle. Conventional solutions to this problem, such as automated emergency braking (AEB) and forward collision warning (FCW), are evasive features that do not proactively alert the driver to a potential future concern. Because these conventional solutions are reactive, there is little or no time for the driver or the vehicle to react, such as modifying operation of the vehicle (e.g., a path or heading) to entirely avoid the encounter. Accordingly, while such conventional encounter avoidance systems for vehicles do work well for their intended purpose, there exists an opportunity for improvement in the relevant art.

### SUMMARY

According to one aspect of the invention, a vehicle-related event recognization and alert system is presented. In one exemplary implementation, the vehicle-related event recognization and alert system comprises a computing server associated with an original equipment manufacturer (OEM) of a plurality of OEM vehicles, the computing server being configured to receive training data relating to a plurality of vehicle-related events, each vehicle-related event being a situation in which an encounter between a particular OEM vehicle and one or more objects occurred and train a vehicle-related event recognization model based on the received training data, wherein the trained vehicle-related event recognization model is configured to recognize a plurality of vehicle-related events and to be executed based on a set of input data to generate a model output indicative of one or more recognized vehicle-related events, and a computing device associated with the OEM, the computing device being configured to obtain the model output and selectively generate an alert for the one or more recognized vehicle-related events.

In some implementations, the computing device is a control system of a vehicle, and wherein the vehicle is one of the plurality of OEM vehicles. In some implementations, the control system is configured to determine a set of vehicle information indicative of a state of the vehicle, wherein the set of vehicle information is the set of input data for the trained vehicle-related event recognization model. In some implementations, the set of vehicle information includes at least one of (i) information captured by a set of perception sensors of the vehicle and (ii) vehicle-to-anything (V2X) information obtained by the vehicle. In some implementations, the plurality of vehicle-related events includes at least one of (i) accidents, (ii) police chases, (iii) public threats, (iv) careless driving, (v) roadside events, (vi) fire incidents, and (vii) natural disasters.

In some implementations, the computing device is a user device logged into an account or an application associated with the OEM. In some implementations, the model output includes a probability score indicative of a likelihood that a particular recognized vehicle-related event will be encountered by the computing device in the future, and wherein the computing device is configured to generate the alert for the particular recognized vehicle-related event when its probability score satisfies a probability score threshold. In some implementations, the particular recognized vehicle-related event is recognized at a long distance relative to the computing device, and wherein the long distance is a physical distance from the computing device, a time period in advance of the future encounter with the computing device, or a combination thereof. In some implementations, the alert includes at least one of a visual alert, an audio alert, and a haptic alert. In some implementations, the computing device is configured to generate and output different alerts for different recognized vehicle-related events, wherein more intense alerts are provided for more severe recognized vehicle-related events.

According to another aspect of the invention, a vehicle-related event recognization and alert method is presented. In one exemplary implementation, the vehicle-related event recognization and alert method comprises receiving, by a computing server associated with an OEM of a plurality of OEM vehicles, training data relating to a plurality of vehicle-related events, each vehicle-related event being a situation in which an encounter between a particular OEM vehicle and one or more objects occurred, training, by the computing server, a vehicle-related event recognization model based on the received training data, wherein the trained vehicle-related event recognization model is configured to recognize a plurality of vehicle-related events and to be executed based on a set of input data to generate a model output indicative of one or more recognized vehicle-related events, and obtaining, by a computing device associated with the OEM, the model output and selectively generating, by the computing device, an alert for the one or more recognized vehicle-related events.

In some implementations, the computing device is a control system of a vehicle, and wherein the vehicle is one of the plurality of OEM vehicles. In some implementations, the vehicle-related event recognization and alert method further comprises determining, by the control system, a set of vehicle information indicative of a state of the vehicle, wherein the set of vehicle information is the set of input data for the trained vehicle-related event recognization model. In some implementations, the set of vehicle information includes at least one of (i) information captured by a set of perception sensors of the vehicle and (ii) V2X information obtained by the vehicle. In some implementations, the plurality of vehicle-related events includes at least one of (i) accidents, (ii) police chases, (iii) public threats, (iv) careless driving, (v) roadside events, (vi) fire incidents, and (vii) natural disasters.

In some implementations, the computing device is a user device logged into an account or an application associated with the OEM. In some implementations, the model output includes a probability score indicative of a likelihood that a particular recognized vehicle-related event will be encountered by the computing device in the future, and wherein the generating of the alert for the particular recognized vehicle-related event is performed when its probability score satisfies a probability score threshold. In some implementations, the particular recognized vehicle-related event is recognized at a long distance relative to the computing device, and wherein the long distance is a physical distance from the computing device, a time period in advance of the future encounter with the computing device, or a combination thereof. In some implementations, the alert includes at least one of a visual alert, an audio alert, and a haptic alert. In some implementations, the computing device is configured to generate and output different alerts for different recognized vehicle-related events, wherein more intense alerts are provided for more severe recognized vehicle-related events.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example long distance vehicle-related event recognization and alert system according to the principles of the present application;

FIG. 2 is a flow diagram of an example method of detecting vehicle-related events for recognization and training an event recognization model according to the principles of the present application;

FIG. 3A is a flow diagram of a first example method for long distance vehicle-related event recognization and vehicle-based alert generation according to the principles of the present application; and

FIG. 3B is a flow diagram of a second example method for long distance vehicle-related event recognization and user device-based alert generation according to the principles of the present application.

### DESCRIPTION

As previously discussed, conventional solutions to the problem of vehicle-related encounters (e.g., collisions or near-miss collisions) include automated emergency braking (AEB) and forward collision warning (FCW). These conventional solutions are evasive features that do not proactively alert the driver to a potential future concern. Because these conventional solutions are reactive, there is little or no time for the driver/vehicle to take remedial action, such as modifying operation of the vehicle (e.g., a path or heading) to entirely avoid the encounter. Accordingly, improved artificial intelligence (AI) based techniques for long distance vehicle-related event recognization and alert generation are presented herein. This feature utilizes AI-powered perception sensors/systems (cameras, sensors, Bluetooth signals, etc.) to enhance the public's (e.g., the OEM users') awareness of their surroundings. More specifically, it assists them in recognizing potential issues or concerns that might be challenging to perceive or identify independently. No existing or conventional system proactively alerts drivers to potential concerns within range (i.e., within a long distance threshold) but not yet in their immediate path. The term “long distance” as used herein refers to a prolonged period of time, a physical distance, or some combination thereof, before a vehicle-related event will occur.

The term “vehicle-related event” as used herein refers to a situation in which a vehicle is or will be involved in, in which an encounter between a vehicle and one or more objects (e.g., a pedestrian user and an OEM-associated device) is possible or likely. These techniques train a vehicle-related event recognization machine learning model (e.g., a neural network type model) based on collected data from a plurality of original equipment manufacturer (OEM) vehicles and/or OEM-associated user devices (e.g., mobile phones logged into an OEM account/application). Each of these OEM vehicles and/or OEM-associated user devices collects and reports data relating to experienced vehicle-related encounters to a remote computing server associated with the OEM. The OEM computing server then trains the vehicle-related event recognization model based on the collected data. This could include, in some implementations, first verifying that the collected data corresponds to a valid vehicle-related event. The trained vehicle-related event recognization model is then utilized to predict potential future vehicle-related events that an OEM vehicle or OEM-associated user device is or will be involved in, in which an encounter involving the OEM vehicle or OEM-associated user device is possible/likely. The execution of the model is performed using state data/information provided by the vehicle/device (geo-location, speed, direction/heading, planned or set route, etc.).

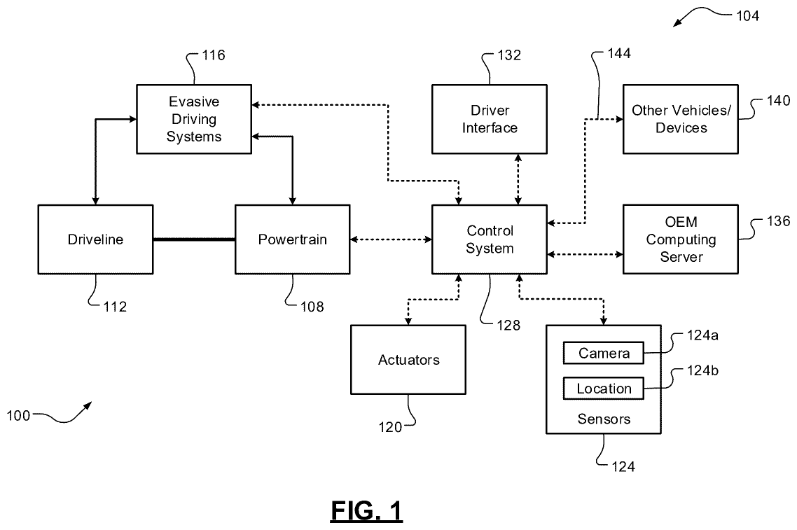

Referring now to FIG. 1, a functional block diagram of a vehicle 100 having an example long distance vehicle-related event recognization and alert generation system 104 according to the principles of the present application is illustrated. It will be appreciated that the event recognization and alert generation system 104 could comprise an OEM computing server 136 and one or both of the vehicle 100 (i.e., a control system 128) and another device 140 (e.g., a user device, such as a mobile phone). The vehicle 100 generally comprises a powertrain 108 configured to generate and transfer drive torque to a driveline 112 for vehicle propulsion. It will be appreciated that the vehicle 100 could be any suitable type of vehicle having any suitable type of powertrain (a conventional engine-only vehicle, mild or plug-in hybrid-electric vehicle (PHEV), an electric-only or battery electric vehicle (BEV), etc.). The vehicle 100 comprises a set of evasive driving systems 116. Each evasive driving system 116 is configured to perform a reactive evasive automated driver-assistance system (ADAS) or autonomous driving feature. Non-limiting examples of the set of evasive driving systems 116 include AEB, FCW, and collision avoidance.

The vehicle 100 includes a plurality of actuators 120 configured to actuate specific components of the vehicle 100 and, more particularly, the powertrain 108 or the driveline 112. Non-limiting examples of these actuators 120 include an accelerator/throttle actuator, a brake actuator, a steering actuator, and alert actuator(s) (a display/light, a speaker, a haptic vibrator, etc.). It will be appreciated that there can be some overlap between the plurality of actuators 120 and the set of evasive driving systems 116. The vehicle 100 also includes a plurality of perception sensors 124 (also “sensors 124”) configured to measure operating parameters of the vehicle 100. Non-limiting examples of these sensors include perception sensors, such as a camera system 124a, a location information system 124b (e.g., for monitoring and obtaining a geo-location, such as coordinates, or the vehicle 100), and other parameters measuring/monitoring sensors (positions, speeds, and/or accelerations, pressures, temperatures, electrical circuit parameters, etc.). The control system 128 controls operation of the vehicle 100 and receives input from the sensors 124 and controls the actuators 120.

The control system 128, for example, controls the powertrain 108 to generate a desired amount of drive torque to satisfy a driver torque request provided by a driver of the vehicle 100 via a driver interface 132 (e.g., an accelerator pedal). At least some of the evasive driving system(s) 116 could be implemented as software at the control system 128. The control system 128 is also configured to communicate (e.g., via a cellular or satellite data network) with the OEM computing server 136 (also, “computing server 136”) associated with the same OEM as the vehicle 100 and located remotely from the vehicle 100 (e.g., at a central station or data center associated with the OEM). The control system 128 is also configured for vehicle-to-anything (V2X) communication with other vehicles/devices 140 (other OEM vehicles, user mobile phones, etc.), also “user device 140,” via one or more short-range wireless communication networks 144 (e.g., Bluetooth®) or other suitable networks. The control system 128 and the computing server 136 are both configured to execute portions of the vehicle-related event recognization and alert generation techniques of the present application, which will now be described in greater detail.

These long distance vehicle-related event recognization and prediction techniques aim to make driving safer, more efficient, and enjoyable by leveraging the power of AI to anticipate and navigate through dynamic and unpredictable road environments. More specifically, these techniques leverage AI-powered cameras and other perception sensors, coupled with collaborative driving assistance technology (e.g., crowdsourcing, machine learning, and Bluetooth communication) to proactively protect and inform the public or, more specifically, users associated with the OEM (e.g., drivers, passengers, OEM-associated pedestrians, etc.) of high-risk events prior to occurrence. The long distance vehicle-related event recognization and prediction using advanced cameras, sensors and Bluetooth signal transmittance for real-time detection and recognition of nearby objects (trees, structures, etc.), pedestrians, and other vehicles on the road. In other words, AI is used to analyze camera/sensor inputs and alert drivers/people nearby of ‘irregular’ driving events. For example only, a driver of an OEM vehicle could be alerted to be cautious of approaching stunt drivers and motorcyclists weaving in-between vehicles on a highway or at a busy intersection.

For example only, an OEM-associated pedestrian standing at a bus stop midnight could receive, via their OEM-associated user device (e.g., a mobile phone) a notification of a suspicious vehicle driving in the opposite direction of traffic a couple of blocks away. Lastly, for example only, AI-powered cameras/sensors could be used to detect pedestrians and cyclists and provide vehicle-based warnings to drivers and trigger evasive action, such as AEB, if necessary. Collaborative driving assistance via crowdsourcing and Bluetooth signals includes vehicle-to-vehicle (V2V) communication, which enables vehicles to communicate with each other to share information about their position, speed, and intentions. Data collection includes collecting data from vehicles equipped with sensors/cameras to understand traffic patterns, road conditions, and potential hazards. Analyzing driver behavior data (e.g., anonymously, or not with respect to a particular driver/profile) includes identifying patterns and potential areas for improvement in road safety. Machine learning and pattern recognition includes predictive analysis, which refers to using machine learning algorithms to predict potential accidents or hazards based on historical data and real-time inputs. Collision avoidance systems as discussed herein include systems that can autonomously steer the vehicle away from obstacles detected (e.g., a detour or route-override on a highway due to construction, where signs may not be visible late at night and navigation is not properly updated).

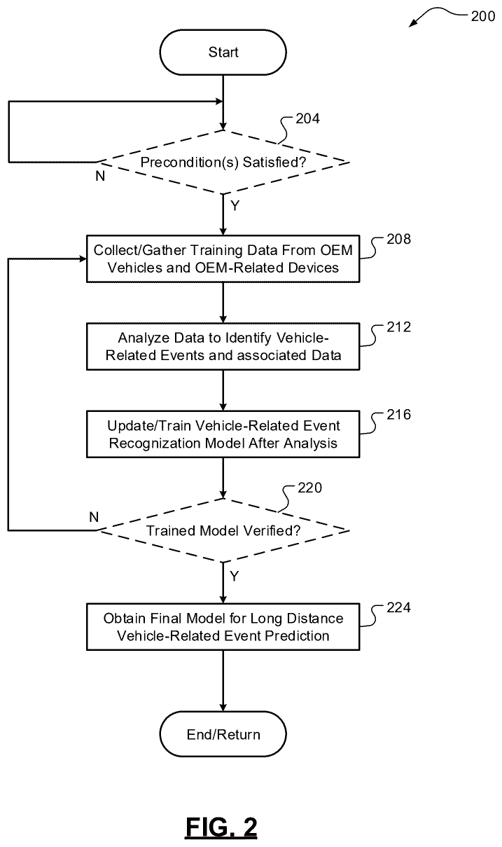

Referring now to FIG. 2 and with continued reference to FIG. 1, a flow diagram of an example method 200 of detecting vehicle-related events for recognization and training an event recognization model according to the principles of the present application is illustrated. While the method 200 specifically references the vehicle 100 and the computing server 136 for descriptive/illustrative purposes, it will be appreciated that the method 200 could be applicable to any suitable vehicles and remote servers associated with a particular OEM. The method 200 begins at 204. At optional 204, the computing server 136 determines whether an optional set of one or more preconditions are satisfied. Non-limiting examples of these preconditions include the computing server 136 being powered up and running and there being no malfunctions or faults present that would negatively impact or otherwise inhibit the operation of the method 200. Another example precondition could be the availability of data for updating/training the vehicle-related event recognization model. When false, the method 200 ends or returns to 204. When true, the method 200 proceeds to 208.

At 208, the computing server 136 receives a large amount of training data. This can include data from the perception sensors 124 of the vehicle 100 (video streams, camera images, RADAR/LIDAR data, etc.), Bluetooth signals (state, position/speed, route/heading, etc.) and any other relevant information relating to V2X or V2V communication by the vehicle 100 and/or the user device 140. At 212, the computing server 136 analyzes this data to identify specific vehicle-related events and the data corresponding thereto (e.g., data/images of vehicle/device states and/or external/environmental events). The vehicle-related events could be predetermined and stored in a database or could be driven (e.g., defined) by user inputs. Non-limiting examples of these vehicle-related events include accidents, police chases, public threats (e.g., armed gunman), careless driving, roadside events, fire incidents, and mother nature or natural disasters (e.g., extreme weather, such as heavy wind/rain due to tornadoes or hurricanes). It will be appreciated that these are merely example vehicle-related events and that there could be many more/other vehicle-related events that are analyzed by the computing server 136. After analyzing the collected data and associating the data with the various vehicle-related events at 212, the computing server 136 then, at 216, updates or trains the vehicle-related event recognization machine learning model (e.g., a neural network type model).

At optional 220, the computing server 136 could verify the accuracy or performance of the trained vehicle-related event recognization model by providing sample or test input data and executing the trained model to identify or recognize a specific vehicle-related event and comparing the result(s) to a known or expected output. The output of the trained model could include, for example only, one or more vehicle-related events and a corresponding probability or likelihood score (e.g., 95%) that the particular vehicle-related event is recognized at a long distance from a source vehicle/device. At 224, the computing server 136 obtains a final trained vehicle-related event recognization model for use in recognizing long distance vehicle-related events and thereby predicting an upcoming encounter with a source vehicle/device. The execution of the final trained model could be performed remotely (at the computing server 136), locally (at the vehicle 100 or the user device 140), or by some combination thereof. This could depend, for example, on the processing and/or network capabilities of the vehicle/device. For example, a more powerful vehicle/device processor could handle more local execution tasks, whereas a weaker vehicle/device processor with a high quality network connection could defer more remote processing tasks to the computing server 136.

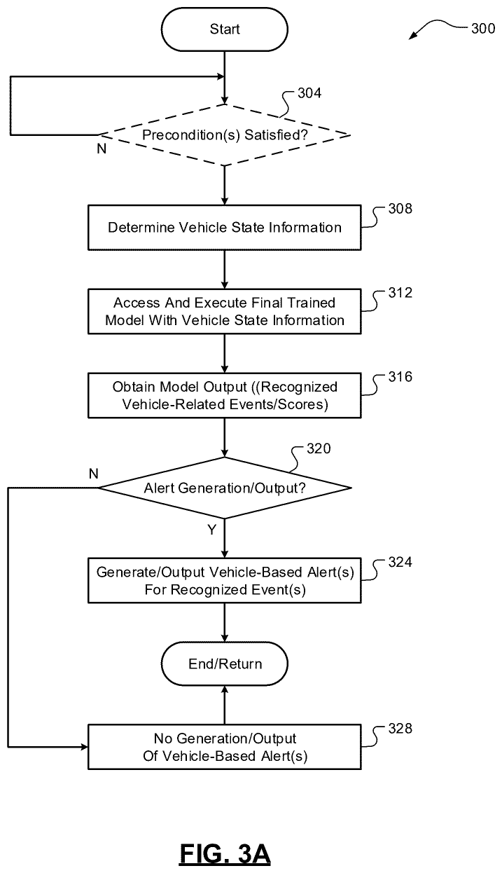

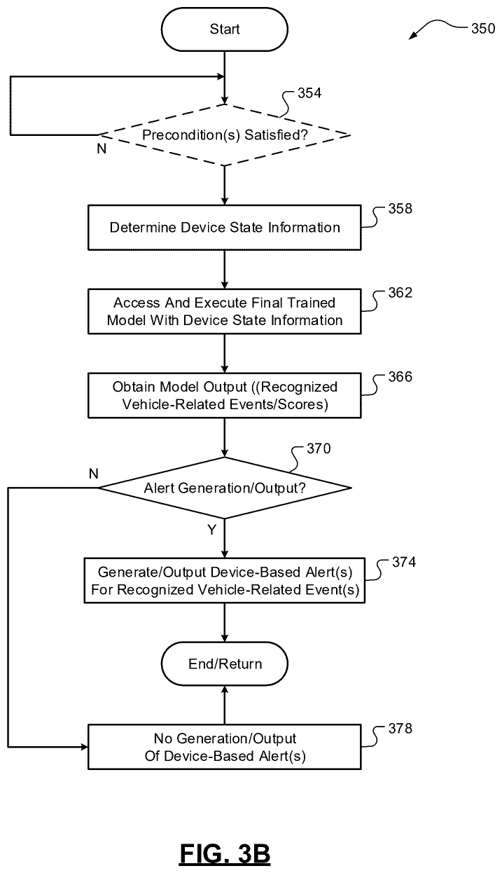

Referring now to FIG. 3A, a flow diagram of a first example method 300 for long distance vehicle-related event recognization and vehicle-based alert generation according to the principles of the present application is illustrated. While the method 300 specifically references the vehicle 100 and its components for illustrative/descriptive purposes, it will be appreciated that the method 300 could be applicable to any suitably configured vehicle 100. The method 300 begins at 304. At 304, the control system 128 determines whether a set of one or more optional preconditions is satisfied. This could include, for example only, the vehicle 100 being powered up and in operation and there being no malfunctions or faults present that would negatively affect or otherwise impact the operation of the techniques of the present application. When false, the method 300 ends or returns to 304. When true, the method 300 proceeds to 308. At 308, the control system 128 determines a set of vehicle information indicative of a state of the vehicle 100. This vehicle information could include, for example only, a position or geo-location of the vehicle 100, a speed of the vehicle 100, a route/heading of the vehicle 100, and any other relevant state information of the vehicle 100 (e.g., a number and/or type of vehicle occupants). The vehicle information could also include other information gathered from other sources, such as via V2V or V2X communication (e.g., Bluetooth signals).

At 312, the control system 128 accesses the trained vehicle-related event recognization model and, using the set of vehicle information and the model, recognizes a vehicle-related event that the vehicle 100 is part of or will be a part of. As previously discussed above with respect to the method 200 of FIG. 2, the model usage/execution could be performed locally (at the vehicle 100), remotely (at the OEM computing server 136), or some combination thereof (e.g., sending the set of vehicle information to the OEM computing server 136 and receiving back the recognized vehicle-related event). At 316, the control system 128 obtains (determines, receives, etc.) the output of the trained vehicle-related event recognization model. As previously discussed, this could include, for example only, one or more recognized vehicle-related events each having a corresponding probability or likelihood score indicative of a likelihood that the particular vehicle-related event is occurring at the long distance and will soon (in the near future) be encountered by the source vehicle 100. At 320, the control system 128 determines whether to generate an alert for any of the recognized vehicle-related events. This determination could include, for example, comparing each probability/likelihood score to a relative score threshold.

For example, if the probability/likelihood score (95%) satisfies the relative score threshold (90%), then an alert for that particular vehicle-related event could be generated at 324 and the method 300 ends or returns to 304. When the relative score threshold is not satisfied by any recognized vehicle-related event probability/likelihood score, no alert could be generated/output at 328 and the method 300 ends or returns to 304. The generation/output of the alert at 324 could include the control system 128 generating one or more control signals for particular actuators 120 and/or the driver interface 132 of the vehicle 100. The alert could be, for example, a visual alert, an audio alert, a haptic alert, or some combination thereof. Different vehicle-related events could have different alerts associated therewith. For example only, certain vehicle-related events could be deemed more severe or important for alert purposes, such as those involving the local authorities (a public threat, a police chase, a fire incident, a missing child or “Amber Alert,” etc.). Such more severe/important vehicle-related events could have more intense alerts associated therewith (louder sounds, stronger haptics, etc.). It will be appreciated that these alerts could also be user-definable such that the user (i.e., the driver) of the vehicle 100 is able to personalize/customize the way that alerts are provided for certain vehicle-related events.

Referring now to FIG. 3B, a flow diagram of a second example method 350 for long distance vehicle-related event recognization and user device-based alert generation according to the principles of the present application is illustrated. While the method 350 specifically references the user device 140 and its related components for illustrative/descriptive purposes, it will be appreciated that the method 350 could be applicable to any suitably configured user device (e.g., a mobile phone). It is also worth noting that this method 350 is very similar to method 300 of FIG. 3A, except for being user device-based instead of vehicle-based. The method 350 begins at 354. At 354, the user device 140 determines whether a set of one or more optional preconditions is satisfied. This could include, for example only, the user device 140 being powered up and in operation and there being no malfunctions or faults present that would negatively affect or otherwise impact the operation of the techniques of the present application. When false, the method 350 ends or returns to 354. When true, the method 350 proceeds to 358. At 358, the user device 140 determines a set of device information indicative of a state of the user device 140.

At 362, the user device 140 accesses the trained vehicle-related event recognization model and, using the set of device information and the model, recognizes a vehicle-related event that the device 140 is part of or will be a part of. This model usage could be performed locally (at the user device 140), remotely (at the OEM computing server 136), or some combination thereof (e.g., sending the set of device information to the OEM computing server 136 and receiving back the recognized vehicle-related event). At 366, the user device 140 the control system 128 obtains (determines, receives, etc.) the output of the trained vehicle-related event recognization model. At 370, the user device 140 determines whether to generate an alert for any of the recognized vehicle-related events. This determination could include, for example, comparing each probability/likelihood score to a relative score threshold. When the relative score threshold is satisfied by one or more recognized vehicle-related event probability/likelihood scores, alert(s) for that/those particular vehicle-related event(s) could be generated at 374 and the method 350 ends or returns to 354. When the relative score threshold is not satisfied by any recognized vehicle-related event probability/likelihood score, no alert could be generated at 378 and the method 350 ends or returns to 354.

It will be appreciated that the terms “controller,” “control system,” and “user device” as used herein refer to any suitable computing device or set of multiple computing devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vehicle-related event recognization and alert system, the vehicle-related event recognization and alert system comprising:
a computing server associated with an original equipment manufacturer (OEM) of a plurality of OEM vehicles, the computing server being configured to:
receive training data relating to a plurality of vehicle-related events, each vehicle-related event being a situation in which an encounter between a particular OEM vehicle and one or more objects occurred, and
train a vehicle-related event recognization model based on the received training data, wherein the trained vehicle-related event recognization model is configured to recognize a plurality of vehicle-related events and to be executed based on a set of input data to generate a model output indicative of one or more recognized vehicle-related events; and
a computing device associated with the OEM, the computing device being configured to obtain the model output and selectively generate an alert for the one or more recognized vehicle-related events.

2. The vehicle-related event recognization and alert system of claim 1, wherein the computing device is a control system of a vehicle, and wherein the vehicle is one of the plurality of OEM vehicles.

3. The vehicle-related event recognization and alert system of claim 2, wherein the control system is configured to determine a set of vehicle information indicative of a state of the vehicle, wherein the set of vehicle information is the set of input data for the trained vehicle-related event recognization model.

4. The vehicle-related event recognization and alert system of claim 3, wherein the set of vehicle information includes at least one of (i) information captured by a set of perception sensors of the vehicle and (ii) vehicle-to-anything (V2X) information obtained by the vehicle.

5. The vehicle-related event recognization and alert system of claim 4, wherein the plurality of vehicle-related events includes at least one of (i) accidents, (ii) police chases, (iii) public threats, (iv) careless driving, (v) roadside events, (vi) fire incidents, and (vii) natural disasters.

6. The vehicle-related event recognization and alert system of claim 1, wherein the computing device is a user device logged into an account or an application associated with the OEM.

7. The vehicle-related event recognization and alert system of claim 1, wherein the model output includes a probability score indicative of a likelihood that a particular recognized vehicle-related event will be encountered by the computing device in the future, and wherein the computing device is configured to generate the alert for the particular recognized vehicle-related event when its probability score satisfies a probability score threshold.

8. The vehicle-related event recognization and alert system of claim 7, wherein the particular recognized vehicle-related event is recognized at a long distance relative to the computing device, and wherein the long distance is a physical distance from the computing device, a time period in advance of the future encounter with the computing device, or a combination thereof.

9. The vehicle-related event recognization and alert system of claim 7, wherein the alert includes at least one of a visual alert, an audio alert, and a haptic alert.

10. The vehicle-related event recognization and alert system of claim 9, wherein the computing device is configured to generate and output different alerts for different recognized vehicle-related events, wherein more intense alerts are provided for more severe recognized vehicle-related events.

11. A vehicle-related event recognization and alert method, the vehicle-related event recognization and alert method comprising:
receiving, by a computing server associated with an original equipment manufacturer (OEM) of a plurality of OEM vehicles, training data relating to a plurality of vehicle-related events, each vehicle-related event being a situation in which an encounter between a particular OEM vehicle and one or more objects occurred;
training, by the computing server, a vehicle-related event recognization model based on the received training data, wherein the trained vehicle-related event recognization model is configured to recognize a plurality of vehicle-related events and to be executed based on a set of input data to generate a model output indicative of one or more recognized vehicle-related events; and
obtaining, by a computing device associated with the OEM, the model output and selectively generating, by the computing device, an alert for the one or more recognized vehicle-related events.

12. The vehicle-related event recognization and alert method of claim 11, wherein the computing device is a control system of a vehicle, and wherein the vehicle is one of the plurality of OEM vehicles.

13. The vehicle-related event recognization and alert method of claim 12, further comprising determining, by the control system, a set of vehicle information indicative of a state of the vehicle, wherein the set of vehicle information is the set of input data for the trained vehicle-related event recognization model.

14. The vehicle-related event recognization and alert method of claim 13, wherein the set of vehicle information includes at least one of (i) information captured by a set of perception sensors of the vehicle and (ii) vehicle-to-anything (V2X) information obtained by the vehicle.

15. The vehicle-related event recognization and alert method of claim 41, wherein the plurality of vehicle-related events includes at least one of (i) accidents, (ii) police chases, (iii) public threats, (iv) careless driving, (v) roadside events, (vi) fire incidents, and (vii) natural disasters.

16. The vehicle-related event recognization and alert method of claim 11, wherein the computing device is a user device logged into an account or an application associated with the OEM.

17. The vehicle-related event recognization and alert method of claim 1, wherein the model output includes a probability score indicative of a likelihood that a particular recognized vehicle-related event will be encountered by the computing device in the future, and wherein the generating of the alert for the particular recognized vehicle-related event is performed when its probability score satisfies a probability score threshold.

18. The vehicle-related event recognization and alert method of claim 17, wherein the particular recognized vehicle-related event is recognized at a long distance relative to the computing device, and wherein the long distance is a physical distance from the computing device, a time period in advance of the future encounter with the computing device, or a combination thereof.

19. The vehicle-related event recognization and alert method of claim 17, wherein the alert includes at least one of a visual alert, an audio alert, and a haptic alert.

20. The vehicle-related event recognization and alert method of claim 19, wherein the computing device is configured to generate and output different alerts for different recognized vehicle-related events, wherein more intense alerts are provided for more severe recognized vehicle-related events.
